(19) United States
(12) Patent Application Publication
(10) Pub. No.: US 2026/0112735 A1
(43) Pub. Date: Apr. 23, 2026

(54) OUTDOOR LI-ION BATTERY ENCLOSURE LI-ION UTILIZING DIRECT AIR COOLING

(71) Applicant: Vertiv Corporation, Westerville, OH (US)

(72) Inventors: Jerome Andrew Maloney, Sugar Grove, IL (US); Paul Gerard Misar, Lombard, IL (US); Matthew Allen Podemski, Auburn, AL (US); Jin Harrison Elkins, Auburn, IL (US)

(21) Appl. No.: 19/362,059

(22) Filed: Oct. 17, 2025

Related U.S. Application Data
(60) Provisional application No. 63/711,008, filed on Oct. 23, 2024.

(51) Int. Cl. H01M 10/6563; H01M 10/613; H01M 10/627; H01M 50/251; H01M 50/30

(52) U.S. Cl. CPC H01M 10/6563; H01M 50/251; H01M 50/394; H01M 10/613; H01M 10/627; H01M 2220/10

(57) ABSTRACT

A battery enclosure can include a cabinet structure, wherein the cabinet structure includes (i) one or more air intake components located on a front door of the cabinet structure and (ii) a gravity damper exhaust assembly located on a rear wall of the cabinet structure. The enclosure can also include a battery housing containing a plurality of batteries carried within the cabinet structure. The plurality of batteries can comprise ten strings of 180 amp hour Li-Ion batteries and the air intake components can comprise one or more intake fans. The one or more intake fans can be located vertically above a topmost battery of the plurality of batteries and the gravity damper exhaust assembly is located on the rear wall of the cabinet structure at a height that substantially half a height of the cabinet.

### CROSS REFERENCE TO RELATED PATENT APPLICATIONS

This application claims the benefit of U.S. Provisional Patent Application No. 63/711,008, filed Oct. 23, 2024, and entitled “OUTDOOR LI-ION BATTERY ENCLOSURE LI-ION UTILIZING DIRECT AIR COOLING,” which is incorporated herein by reference in its entirety.

### BACKGROUND

There is a desire in the industry to use outdoor battery enclosures using lithium-ion (Li-ion) batteries for long-duration DC (direct current) based equipment backup. Such a Li-ion battery enclosure is a candidate to replace a more traditional battery enclosure/cabinet (e.g., one employing VRLA (valve-regulated lead-acid) or Ni-Cad (nickel-cadmium) batteries), due to customer demand. The functional benefit to Li-ion batteries is they have superior battery backup capacity compared to these other battery types in a similar size.

A functional challenge with using Li-ion batteries pertains to their performance capability in high temperature environments. When the Li-ion batteries experience 50° C. during discharging and charging operations, their internal cores can begin to heat-up. When these internal cores reach 60° C., the Li-ion batteries are designed to shut down to avoid catastrophic failure. Thus, typical outdoor battery enclosures that are intended for Li-ion batteries have heretofore used expensive, energy consuming air-conditioning systems for internal enclosure, temperature, and humidity control to avoid this potential thermal shutdown.

### SUMMARY

A battery enclosure can include a base cabinet structure, a front door, an air intake assembly, an exhaust damper, and a series of batteries. The front door can be mounted on the base cabinet structure. The air intake assembly can be carried by the front door, the air intake assembly including at least one intake fan. The exhaust damper can be carried by the base cabinet structure on a side of the base cabinet structure opposite the front door. The series of batteries can be carried within the base cabinet structure, each battery being a lithium-ion (Li-ion) battery, the air intake assembly and the exhaust damper configured to facilitate an air flow for cooling of the batteries.

### BRIEF DESCRIPTION OF THE DRAWINGS

The Detailed Description is described with reference to the accompanying figures.

FIG. 1 is a front isometric view of the Li-ion battery enclosure with the intake shroud exploded, in accordance with an example embodiment of the present disclosure.

FIG. 2 is a front isometric view of the Li-ion battery enclosure, as shown in FIG. 1, with the door open.

FIG. 3 is a rear isometric view of the Li-ion battery enclosure, as shown in FIG. 1.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

### INTRODUCTION

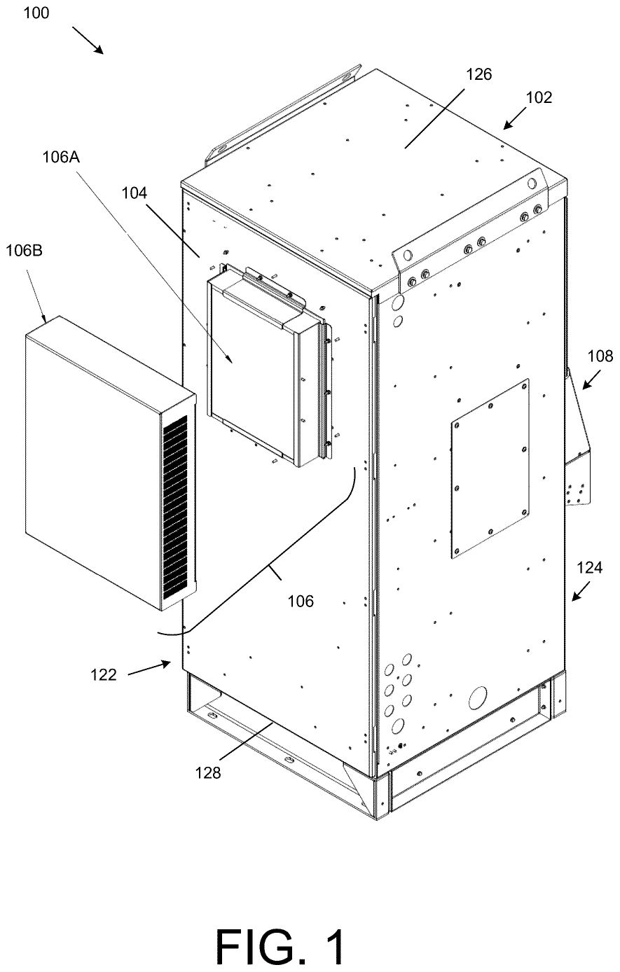

According to an embodiment of the present disclosure, an outdoor Li-ion battery enclosure (e.g., Li-ion battery cabinet), such as illustrated in FIGS. 1-3, can use a direct air-cooling system to provide the necessary temperature and humidity control as an alternative to using a more expensive, energy-consuming air-conditioning system. The present direct air-cooling system utilized in this enclosure can, in one embodiment, have its intake components (e.g., an intake fan and related filter) carried on its front door and can have a gravity damper exhaust assembly carried on its rear wall. Utilizing a direct air-cooling system instead of air-conditioning systems to provide the internal enclosure temperature and humidity control in high ambient temperature environments can create a significant competitive advantage with respect to enclosure cost and energy consumption cost for the end user of such cabinets.

In an embodiment, the present outdoor Li-ion battery enclosure can be used in conjunction with an electronics cabinet (e.g., commonly referred to as an OSP (outside plant) cabinet) employing both heat-generating electronics (e.g., telecommunications equipment) in an upper portion of the cabinet and a series of lithium-ion (Li-ion) batteries in the lower portion thereof. The electronics cabinet is further described in two related applications assigned to Vertiv (U.S. Provisional Application No. 63/701,045, filed Sep. 30, 2024; and U.S. Provisional Application No. 63/698,892, filed Sep. 25, 2024), incorporated by reference thereto. The present outdoor Li-ion battery enclosure can have a similar form factor as the electronics cabinet and may be constrained to have system compatibility therewith. It is important to note that present outdoor Li-ion battery enclosure can take several alternate forms that may not be constrained by compatibility requirements with other existing enclosures. For compatibility with the related electronics cabinet mentioned above, the Li-ion battery enclosure can be designed for utilizing 10 strings of 180 amp-hour Li-ion batteries. The chosen Li-ion battery to be used can be approximately 21.5″ wide×28.5″ deep and 2RU tall.

In an embodiment, the present outdoor Li-ion battery enclosure can include a cabinet with a front door carried thereby (e.g., hingedly mounted thereto) and where the cabinet defines a cabinet rear. The front door can have a filter/vent system mounted thereto, with the filter/vent system configured to cool the Li-ion batteries located in the cabinet of the battery enclosure. The vent system can include one or more intake fans for generating airflow into the cabinet and around the Li-ion batteries carried therein. The cabinet rear can have an exhaust damper mounted thereto, where the exhaust damper can be configured to allow warm and/or hot air to escape the battery enclosure and to prevent the back flow of contaminants into the cabinet.

The filter vent system and the exhaust damper together can primarily facilitate the expulsion of hot air (e.g., generated by the operational resistance of the batteries) from the cabinet. The airflow and related cooling promoted by the presence of the filter vent system and the exhaust damper obviate the need for an air conditioning system to keep the Li-ion batteries from exceeding their maximum safe operating temperature. The adequate cooling by the present airflow system alone can permit the use of Li-ion batteries in such a battery enclosure where, for example, the use of air conditioning is not necessarily feasible and/or is at least cost prohibitive.

### Description of Example Embodiments

FIGS. 1-3 illustrate an outdoor Li-ion battery enclosure 100 (hereinafter battery enclosure 100), in accordance with an example embodiment of the present disclosure. The battery enclosure 100 can generally include a base cabinet structure (e.g., made up of top, bottom, and side walls not necessarily individually identified) 102 (hereinafter referred to as cabinet 102), a front door 104, an air intake assembly 106, an exhaust damper 108 (e.g., in a form of a gravity damper exhaust), and a series of batteries 110A. In an embodiment, the cabinet 102 of the battery enclosure 100 can define a cabinet front 122, a cabinet back 124, a cabinet top 126, and a cabinet floor 128, with the cabinet 102 defining a cabinet interior 130 bounded thereby. The series of batteries 110A resides in a lower region of the cabinet interior 130, further defining a battery housing 110B. A front door 104 can be movably mounted (e.g., via one or more hinges (not labeled)) to the cabinet front 122 to facilitate access to the cabinet interior 130. The front door 104 can further carry the air intake assembly 106, with the air intake assembly 106 configured to facilitate the intake of filtered ambient air into the cabinet interior 130 and to facilitate the movement of that filtered ambient air toward and through the cabinet interior 130 and/or around the series of batteries 110A within the battery housing 110B. The resultant airflow from the air intake assembly 106 can thereby help to cool the series of batteries 110A.

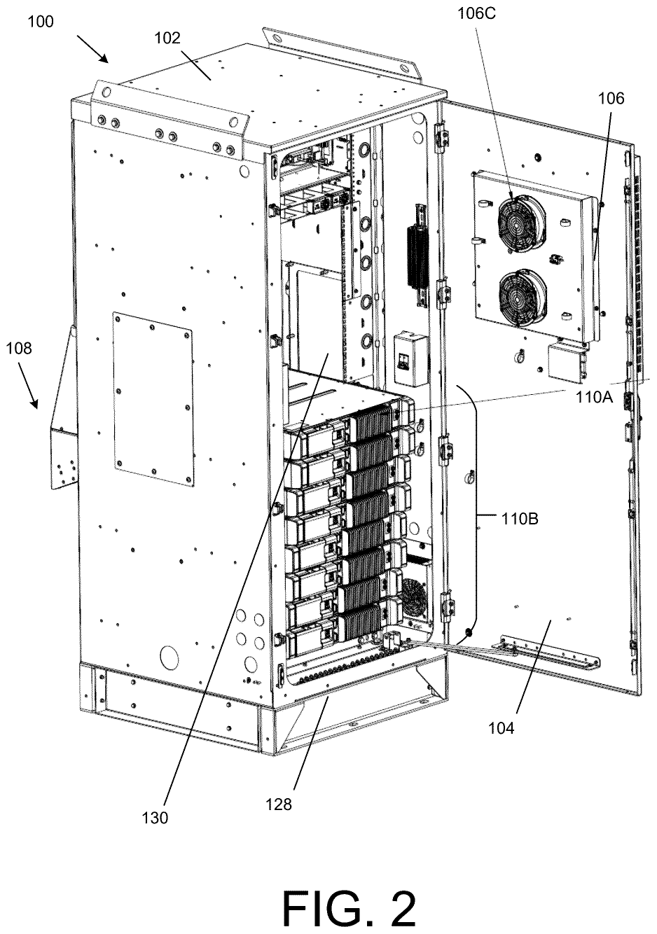

As best seen in FIGS. 1 and 2, an air intake assembly 106 can include, for example, an intake filter 106A; an intake filter shroud 106B; and one or more intake fans 106C (of which two are illustrated). The air intake filter 106A and the air intake filter shroud 106B can be carried (e.g., operatively mounted) to an outside (e.g., ambient-facing side) of the front door 104, and the one or more intake fans 106C can be mounted on an inside (e.g., cabinet interior-facing side) of the front door 104, with the front door 104 configured with a port therethrough (not expressly shown) to facilitate air flow from the outside (ambient) between the air intake filter 106A and the one or more intake fans 106C. The intake filter 106A, the intake filter shroud 106B, and the one or more intake fans 106C, along with the port through the front door 104, can together help define an air intake flow path from the ambient to the cabinet interior 130, including the battery housing 110B. The air intake filter shroud 106B can be configured to substantially cover and protect the intake filter 106A, while still defining one or more air flow paths (not labeled) to the intake filter 106A. In an embodiment, the intake filter 106A can be removably mounted (relative the front door 104) to facilitate the replacement and/or cleaning thereof. It is to be understood that the position and/or number of intake fans 106C and/or air intake assemblies 106 can be chosen based on cooling needs and/or form-factor constraints of the battery enclosure employed.

The intake fans 106C can be electrically powered by a power supply other than the series of batteries 110A. The intake fans 106C can be configured to draw ambient air through the air intake filter 106A and the air intake filter shroud 106B into the cabinet interior 130; circulate air flow through the cabinet interior 130, including the battery housing 110B, and vent air out of the cabinet interior 130 through the exhaust damper 108. The intake fans 106C drive air across an airflow path entering the battery enclosure 100 at the air intake filter 106A and the air intake filter shroud 106B, and exiting the battery enclosure 100 at the exhaust damper 108, above the battery housing 110B. The vented air carries heat from the series of batteries 110A out of the battery enclosure 100, without cooling by refrigerants, condensers, or evaporators.

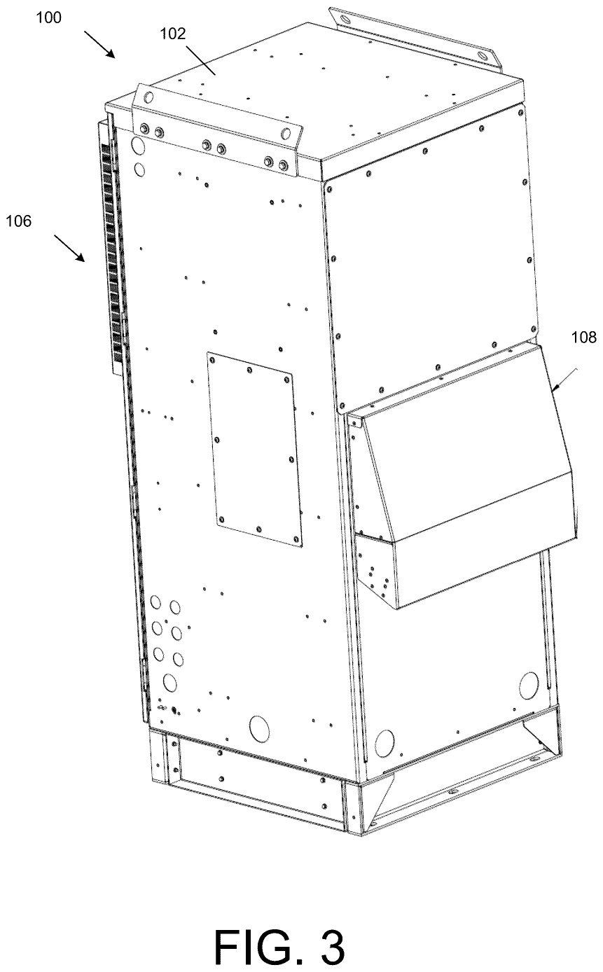

As likely best seen from FIG. 3, the exhaust damper 108 can exhaust and/or vent warm air from the battery enclosure 100. The exhaust damper 108 can be mounted or otherwise carried on the cabinet back 124, with the cabinet back 124 configured to permit air flow therethrough (e.g., via a port therethrough) proximate the exhaust damper 108 for venting purposes. In an embodiment, the exhaust damper 108 can be relatively centrally located relative to the cabinet back 124 to exhaust warm air generated from cooling the series of batteries 110A. In an embodiment, the exhaust damper 108 can be downwardly directed to minimize the possibility of precipitation (e.g., rain and/or snow) and/or dust from entering therethrough into the cabinet interior 130. It is to be understood that, in some embodiments, the battery enclosure 100 can include more than one exhaust damper 108, and/or the position of the one or more exhaust dampers 108 can be chosen to maximize the exhaust efficiency and/or to work within space constraints of the form factor of the battery enclosure being employed. It is to be understood that a given exhaust damper 108 can further employ a bug screen/mesh (not shown) proximate an exit thereof to minimize encroachment of bugs/insects into the cabinet interior 130.

In an embodiment, due to the size of the 180 amp-hour Li-ion battery relative to the form factor of the enclosure illustrated in FIGS. 1-3, the intake fans 106C can be vertically located above the topmost Li-ion battery 110A, as can be particularly seen in FIG. 2, to avoid interference issues therebetween when the front door 104 is closed. Vertically locating the exhaust damper 108 (e.g., a gravity damper exhaust) approximately halfway up the height of the enclosure (as best shown in FIG. 3) can optimize the airflow pattern from the intake fans 106C through the cabinet interior 130 of the battery enclosure 100 and help effectively cool the Li-ion batteries 110A, accordingly. The assembly method for 180 amp-hour Li-batteries 110A in this application can follow the assembly method detailed in a related Vertiv-assigned application, U.S. Provisional Application No. 63/698,892, filed Sep. 25, 2024, the content of which is incorporated by reference thereto. In embodiments, the batteries 110A can be Li-Ion batteries (e.g., 180 Amp-hour Li-ion batteries) provided in sets including at least two batteries, wherein each battery set is positioned about a different vertical plane to provide spacing for routing battery cables. In an embodiment, the topmost set of Li-ion batteries 110A can have 2 RU of space between it and the set below it for cable routing and management. That said, it is to be understood that the present disclosure is not limited to the battery enclosure 100 depicted in FIGS. 1-3 and can take alternate forms that can be driven by the form factor and system requirements of the intended use application.

The battery enclosure 100 can further include at least one processor for controlling the operation of the various components (e.g., intake fans 106C; batteries 110A (including the charging/discharging thereof) of the battery enclosure 100. The at least one processor can be implemented as any suitable processor(s), such as at least one general purpose processor, at least one central processing unit (CPU), at least one image processor, at least one graphics processing unit (GPU), at least one field-programmable gate array (FPGA), and/or at least one special purpose processor configured to execute instructions for performing (e.g., collectively performing if more than one processor) any or all of the operations disclosed throughout.

In one embodiment, several portions of the subject matter described herein can be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application-specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein can be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system can be implemented utilizing any suitable commercially available components, such as those typically found in data computing/communication and/or network computing/communication systems.

As used throughout and as would be appreciated by those skilled in the art, “at least one non-transitory computer-readable medium” or “memory” can refer to at least one non-transitory computer-readable medium (e.g., at least one computer-readable medium implemented as hardware); at least one non-transitory processor-readable medium, at least one memory (e.g., at least one nonvolatile memory, at least one volatile memory, or a combination thereof); e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be implemented (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein can be implemented, none of which is inherently superior to the other in that any vehicle to be utilized is a choice dependent upon the context in which the vehicle will be deployed and the specific concerns (e.g., speed, flexibility, or predictability) of the implementer, any of which may vary.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A battery enclosure comprising:
a cabinet structure, wherein the cabinet structure includes (i) one or more air intake components located on a front door of the cabinet structure and (ii) a gravity damper exhaust assembly located on a rear wall of the cabinet structure; and
a battery housing configured to contain a plurality of batteries within the cabinet structure;
wherein the one or more air intake components are configured to drive air across an airflow path entering the battery enclosure at the one or more air intake components, and exiting the battery enclosure at the gravity damper exhaust assembly, above the battery housing.

2. The battery enclosure of claim 1, wherein the battery housing is configured to contain ten strings of 180 amp hour Li-Ion batteries.

3. The battery enclosure of claim 1, wherein the air intake components comprise one or more intake fans.

4. The battery enclosure of claim 3, wherein the one or more intake fans are located vertically above the battery housing.

5. The battery enclosure of claim 1, wherein the gravity damper exhaust assembly is located on the rear wall of the cabinet structure at a height that substantially half a height of the battery enclosure.

6. The battery enclosure of claim 1, further comprising a cable routing and management area.

7. The battery enclosure of claim 1, wherein the battery enclosure is configured for placement outdoors.

8. The battery enclosure of claim 7, wherein the gravity damper exhaust assembly further comprises a bug screen or mesh.

9. A battery enclosure comprising:
a cabinet structure, wherein the cabinet structure includes (i) one or more intake fans located on a front door of the cabinet structure and (ii) a gravity damper exhaust assembly located on a rear wall of the cabinet structure; and
a battery housing configured to contain ten strings of 180 amp hour Li-Ion batteries carried within the cabinet structure;
wherein the one or more intake fans are configured to drive air across an airflow path entering the battery enclosure at the one or more intake fans, and exiting the battery enclosure at the gravity damper exhaust assembly, above the battery housing.

10. The battery enclosure of claim 9, wherein the one or more intake fans are located vertically above the battery housing.

11. The battery enclosure of claim 9, wherein the gravity damper exhaust assembly is located on the rear wall of the cabinet structure at a height that substantially half a height of the battery enclosure.

12. The battery enclosure of claim 9, further comprising a cable routing and management area.

13. The battery enclosure of claim 9, wherein the battery enclosure is configured for placement outdoors.

14. The battery enclosure of claim 13, wherein the gravity damper exhaust assembly further comprises a bug screen or mesh.

15. A battery enclosure configured for placement in a location outdoors, the cabinet comprising:
a cabinet structure, wherein the cabinet structure includes (i) a plurality of intake fans located on a front door of the cabinet structure and (ii) a gravity damper exhaust assembly located on a rear wall of the cabinet structure; and
a battery housing configured to contain a plurality of 180 amp hour Li-Ion batteries carried within the cabinet structure;
wherein the plurality of intake fans are configured to drive air across an airflow path entering the battery enclosure at the plurality of intake fans, and exiting the battery enclosure at the gravity damper exhaust assembly, above the battery housing.

16. The battery enclosure of claim 15, wherein the plurality of Li-Ion batteries comprises ten strings of 180 amp hour Li-Ion batteries.

17. The battery enclosure of claim 15, wherein the plurality of intake fans are located vertically above the battery housing.

18. The battery enclosure of claim 15, wherein the gravity damper exhaust assembly is located on the rear wall of the cabinet structure at a height that substantially half a height of the battery enclosure.

19. The battery enclosure of claim 15, further comprising a cable routing and management area.

20. The battery enclosure of claim 15, wherein the gravity damper exhaust assembly further comprises a bug screen or mesh.
